(19) United States
(12) Patent Application Publication
(10) Pub. No.: US 2006/0261012 A1
(43) Pub. Date: Nov. 23, 2006

(54) Centrifugation process for increasing solid containment in powdered paste

(76) Inventors: Jenn-Shing Wang, Shin Shi Shiang (TW); Chih-Cheng Chen, Shin Shi Shiang (TW); Chia-Jung Lin, Shin Shi Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/132,371

(22) Filed: May 19, 2005

(51) Int. Cl. C02F 1/48; C02F 1/38

(52) U.S. Cl. 210/695; 210/787; 210/806; 494/37

(57) ABSTRACT

A centrifugation process to increase solid containment in a powdered paste is related to a fast, simple and higher value added process. The paste availed from a primary centrifugation is blended to destroy powder bridge in the paste. The solid and the liquid are further separated with a secondary centrifugation to significantly improve centrifugation efficiency and help avail the paste with a higher solid containment. The powder is constantly distributed due to the blending thus to minimize potential flaws found in the subsequent process.

### BACKGROUND OF THE INVENTION

(a) Field of the Invention

The present invention is related to a centrifugation process for increasing solid containment in powdered paste, and more particularly, to one that has the paste from a primary centrifugation placed in a blender to destroy powder bridge in the paste before further separating the solid from the liquid using a secondary centrifugation.

(b) Description of the Prior Art

How to increase solid containment in powdered paste has become an issue pending urgent solutions as the demand on powdered past increases, the significantly increased transportation and storage costs due to lower powder containment, and higher powder containment required in the subsequent extrusion process.

The method of sedimentation by centrifugation to reinforce the sedimentation of the particles facilitates the process of sedimentation for the particles. In the field of centrifugal force, the man-made centrifugal acceleration could be even several hundreds times than that found with the inherited central gravity in the nature, resulting in that it is much more effective for the objects in small grain and density to settle in the centrifugal force field than that in the gravitational field.

Centrifugal sedimentation is a highly effective sedimentation method and has been adopted as a concentration method for the powdered paste. Centrifugal sedimentation relates to a process of operating on the difference of density between two phases of liquid and solid by rapid sedimentation and separation of those solid particles dispersed in the suspension liquid in a field of centrifugal field, and the process depending on the different separation demands respectively completes concentration, clarification and grading. In the working mode, this process comes up with in two types, intermittent and continuous feedings. However, the results are not ideal to cope with the requirements of the higher solid containment.

High solid containment is very critical to the concentrated nano-paste because that the concentrated paste is demanded to provide easy transportation, delivery and application similar to compression and decompression processes with a computer data file. However, the concentration process requires that it shall not damage the dispersion of the powders; that the de-concentration should involve only a summary process (e.g., adding water) to restore the properties of the paste; and that the concentrated paste shall provide a long shelf life without deterioration.

Though the centrifugation process does increase the solid containment of the paste, it also winds up that the rougher powders or agglomerates settles fast for being subject to great centrifugal force while the finer powders or agglomerates stay in the upper layer of the paste. Consequently, the extent of increased solid containment is very limited after the separation of solid from the liquid even provided with extended working hours for the process. As illustrated in FIG. 2, taking the nano-aluminum oxide paste in a grain size smaller than 100 nm availed from chemical reaction of the solution having it solid containment smaller than 19 vol % and pH of 11.4 for example, its solid containment reaches a constant after five minutes within a time frame of 2-10 minutes of changes in solid containment at a centrifugal speed of 6,000 rpm, evidencing that the existent of powder bridge exists in the nano-paste upon the completion of a primary centrifugation.

Bridge destruction technique though having been already applied in the transmission of the edible, pharmaceutical, ceramic and chemical engineering industries, has not yet been designed for the concentrated paste. There is also the absence in those processes documented of mentioning any process that involves the destruction of the paste bridge developed after the primary centrifugation.

### SUMMARY OF THE INVENTION

The primary purpose of the present invention is to provide a centrifugation process that increases the solid containment in a powdered paste. To achieve the purpose, the paste availed from a primary centrifugation is blended to destroy powder bridge in the paste. Since the extent of water containment of the paste will affect the transportation cost, packaging, storage and subsequent process, the paste is then put into a secondary centrifugation to separate the solid from the liquid without deteriorating the paste since heating the paste is not required. Accordingly, the present invention not only significantly improves centrifugation efficiency but also helps attain higher solid containment in the past, for example, 36% solid containment in a paste of nano-aluminum oxide being promoted to 54.6% or higher. The present invention provides a fast sedimentation for the powder in favor of commercial scale production and advantages of fast, easy and low production cost process.

### BRIEF DESCRIPTION OF THE DRAWINGS

FIG. 1 is a table showing the comparison of the solid containment of particles in a paste respectively availed from the process of the present invention and a conventional primary centrifugation.

FIG. 2 is a drawing showing the impacts of the length of time upon the solid containment.

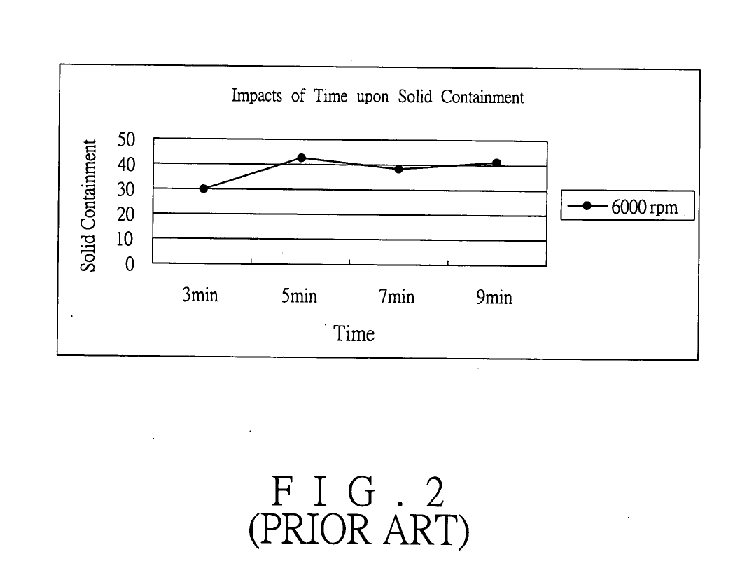

### DETAILED DESCRIPTION OF THE PREFERRED EMBODIMENTS

The present invention relates to a process of increasing the solid containment in a powdered paste involved a primary centrifugation, blending, and a secondary centrifugation. It achieves its purpose of increasing the solid containment by taking advantage of the non-addition and non-heating features of the powdered paste. Whereas most of the residual water containment stays among contact surfaces of particles overlapped on one another in the powders, the blending results in re-arrangement of the powders and effective and denser accumulation of the rougher and finer powders to increase density as that can be done in batching process. The secondary centrifugation permits the water containment to move upward along the spacing among the powders in the centrifugal tube and drained due to the greater density of the powders than that of the liquid. Meanwhile, the process of the present invention is drastically different from the conventional process in that the former is applicable to nano-powder or general powder. The process of the present invention not only increases the solid containment but also upgrades the value of the paste, plus the advantages of constantly distributed powders due to the blending and reduction of potential flaws found in the subsequent process. The present invention is innovative since all of its advantages are all new applications not ever documented and it is particularly useful in meeting the special requirements of nano-powder.

In a first preferred embodiment of the present invention, the process conditions include:
1. Primary Centrifugation: 10000 rpm, 10 minutes, the clear water on the upper layer of the paste is removed by separation upon the completion of the primary centrifugation.
2. Blending: 5 rpm, 10 minutes.
3. Secondary Centrifugation: 10000 rpm, 10 minutes.

The energy is the same in both of the primary and the secondary centrifugation procedures. Wherein, the purpose of the blending is to destroy the powder bridge thus to mix the rougher and finer powders respectively existing in the upper and the lower layers for achieving even more dense accumulation of the powders.

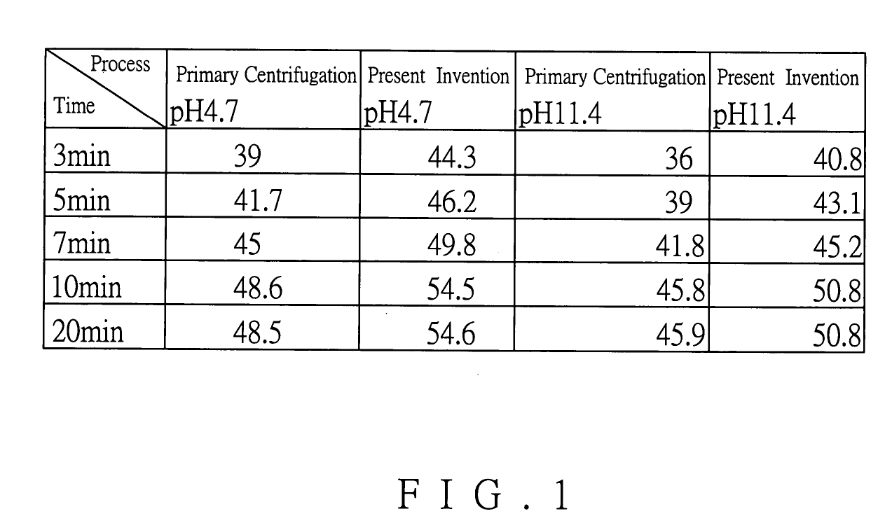

Referring to FIG. 1 for the comparison of the solid containment of aluminum oxide between the present invention and the conventional process, it is found that the solid containment after the primary centrifugation ranges between 36˜48.5 vol %; and the present invention after the secondary centrifugation, 40.8˜54.6 vol % showing that the effective increase of solid containment of aluminum oxide after blending followed by the secondary centrifugation.

Whereas the molecular weight of the acid is less than that of the alkali, higher yield of solid containment is achieved in the acid status either in the primary or the secondary centrifugation. 50 vol % solid containment is the lower limit of the direct application of the nano-aluminum oxide to the extrusion of ceramic. Excessive water containment will cause the extruded ceramic to deform for getting too soft. The blending procedure is to provide consistent distribution of the powders and a dense accumulation between the rougher and the finer powders to significantly reduce the molding and sintering flaws such as cracks due to inconsistent expansion in the application of the centrifugal powders. Those flaws cannot be solved solely by centrifugation. No mild addition of chemical agent is needed in the blending environment to preserve the original physical properties of the solution for providing highly added value application. The critical and practical features of the present invention are thus self-explanatory.

Accordingly, the solid-liquid separation in the primary centrifugation may be used in conjunction with concentration followed by sedimentation or filtration. Wherein, the filtration is related to filtration by pressure or vacuum.

When the powdered paste enters into the blending procedure, both of power and time are adjusted to achieve mixing powders in the upper and the lower layers in the paste either by a mechanical blending, magnetic force blending or air bulb blending method.

Depending on the material, source, production parameters and quality control, further separation of solid from liquid or dehydration may be required on the part of concentration process, such as dehydration of sludge, pharmaceutical extraction, removal of solution upon the synthesis of powder, and mineral sorting. The product in process after blending may be subject to the secondary centrifugation to thoroughly separate the solid from the liquid to avail two parts of powders and clear liquid as attempted by the process of the present invention.

The material for the powdered paste may be of metal, ceramic, macromolecule, or compound material. The present invention is applicable to those powders since they all feature mixed solid and liquid phases and face the similar problems of concentration.

Furthermore, in the process of the centrifugation for any of those pastes, a blender may be incorporated to a centrifuge so to complete the primary centrifugation and the blending on the same unit, then followed by the secondary centrifugation to separate solid from liquid, thus to save time and energy to facilitate automation process.

The centrifugation process to increase solid containment in a powdered paste of the present invention is applicable to sludge dehydration, pharmaceutical extraction, removal of solution after powder synthesis, and mineral sorting, and provides benefits of reduced transportation costs, and potential problems in the packaging, storage and subsequent process. Wherein the heating or additive is not required in the process of the present invention, the paste processed will not get deteriorated thus to significantly improve separation efficiency while yielding the paste of higher solid containment and clear solution of higher purity. The present invention offers a fast and easy process with higher added value by including the blending procedure to provide consistent powder for facilitating reduction of potential flaws in the subsequent process.

What is claimed is:

1. A centrifugation process to increase solid containment in powdered paste comprising a primary centrifugation, blending, and a secondary centrifugation; the powdered paste completed with the primary centrifugation first being blended to destroy powder bridge; then followed with a solid-liquid separation during the secondary centrifugation.

2. The centrifugation process to increase solid containment in powdered paste of claim 1, wherein the blending is done by mechanical, magnetic, or air bulb force.

3. The centrifugation process to increase solid containment in powdered paste of claim 1, wherein either sedimentation or filtration is used in the solid-liquid separation during the primary centrifugation.

4. The centrifugation process to increase solid containment in powdered paste of claim 3, wherein filtration by pressure or by vacuum is provided for the solid-liquid separation.

5. The centrifugation process to increase solid containment in powdered paste of claim 1, wherein the material of the powdered paste is metal, ceramic, macromolecule, or compound material.

6. The centrifugation process to increase solid containment in powdered paste of claim 1, wherein both the primary and the secondary centrifugation procedures are done in a centrifuge, a blending device is provided in the centrifuge, and the blending is completed in the centrifuge.
